(19) United States
(12) Patent Application Publication
(10) Pub. No.: US 2011/0280528 A1
(43) Pub. Date: Nov. 17, 2011

(54) CABLE ASSEMBLY WITH ELECTRICAL AND OPTICAL TRANSMITTING

(75) Inventor: JERRY WU, Irvine, CA (US)

(73) Assignee: HON HAI PRECISION INDUSTRY CO., LTD., New Taipei (TW)

(21) Appl. No.: 13/105,939

(22) Filed: May 12, 2011

(30) Foreign Application Priority Data
May 12, 2010 (CN) 201010170226.8

(51) Int. Cl. G02B 6/44

(52) U.S. Cl. 385/101

(57) ABSTRACT

An cable assembly (1000) includes an insulative housing (1); a plurality of terminals (212, 222) received in the insulative housing; an optical module (8); a hybrid cable (6A) including at least two STP or FTP wires (601A) and a fiber cable (602), the STP or FTP wires electrically connected with the terminals, the fiber cable optically connected with the optical module; and the two STP or UTP wires symmetrically arranged with regarding to the optical cable.

### FIELD OF THE INVENTION

The present invention generally relates to a cable assembly, and more particularly to a cable assembly adapted for electrical and optical transmitting.

### DESCRIPTION OF PRIOR ART

Nowadays, an electrical device has become lower profile and multi-functional, and a cable assembly for the electrical device is also capable of high-speed transmitting, and reliably connection and easily detachable with its counterpart.

Cable assemblies in accordance with USB, SATA, HDMI, SAS and Displayport protocol have been widely applied in different kinds of electronic devices. The aforementioned cable assemblies depend on metallic terminals and copper wires to achieve electrical signal transmitting. However, transmitting speed is limited via electrical signal transmitting. In other aspect, as transmitting speed increasing, a structure of the cable assembly becomes complex, and a total dimension of the cable assembly is increasing.

Hence, an improved cable assembly is highly desired to overcome the aforementioned problems.

### SUMMARY OF THE INVENTION

Accordingly, an object of the present invention is to provide a lower profile cable assembly capable of transmitting both electrical signal and optical signal.

In order to achieve the object set forth, a cable assembly in accordance with the present invention comprises an insulative housing; a plurality of terminals received in the insulative housing; an optical module; a hybrid cable including at least two STP or FTP wires and a fiber cable, the STP or FTP wires electrically connected with the terminals, the fiber cable optically connected with the optical module; and the two STP or UTP wires symmetrically arranged with regarding to the optical cable.

Other objects, advantages and novel features of the invention will become more apparent from the following detailed description when taken in conjunction with the accompanying drawings.

### BRIEF DESCRIPTION OF THE DRAWINGS

FIG. 1 is an exploded, perspective view of a cable assembly of a first embodiment in accordance with the present invention;

FIG. 2 is similar to FIG. 1, but viewed from another aspect;

FIG. 3 is similar to FIG. 1, but viewed from other aspect;

FIG. 4 is a partially assembled view of the cable assembly;

FIG. 5 is similar to FIG. 4, but viewed from other direction;

FIG. 6 is another partially assembled view of the cable assembly;

FIG. 7 is an assembled, perspective view of the cable assembly;

FIG. 8 is a cross-section view of a cable of the first embodiment;

FIG. 9 is a cross-section view of a cable of a second embodiment;

FIG. 10 is a cross-section view of a cable of a third embodiment;

FIG. 11 is a cross-section view of a cable of a fourth embodiment; and

FIG. 12 is a cross-section view of a cable of a fifth embodiment;

### DETAILED DESCRIPTION OF PREFERRED EMBODIMENTS

Reference will now be made in detail to the preferred embodiment of the present invention.

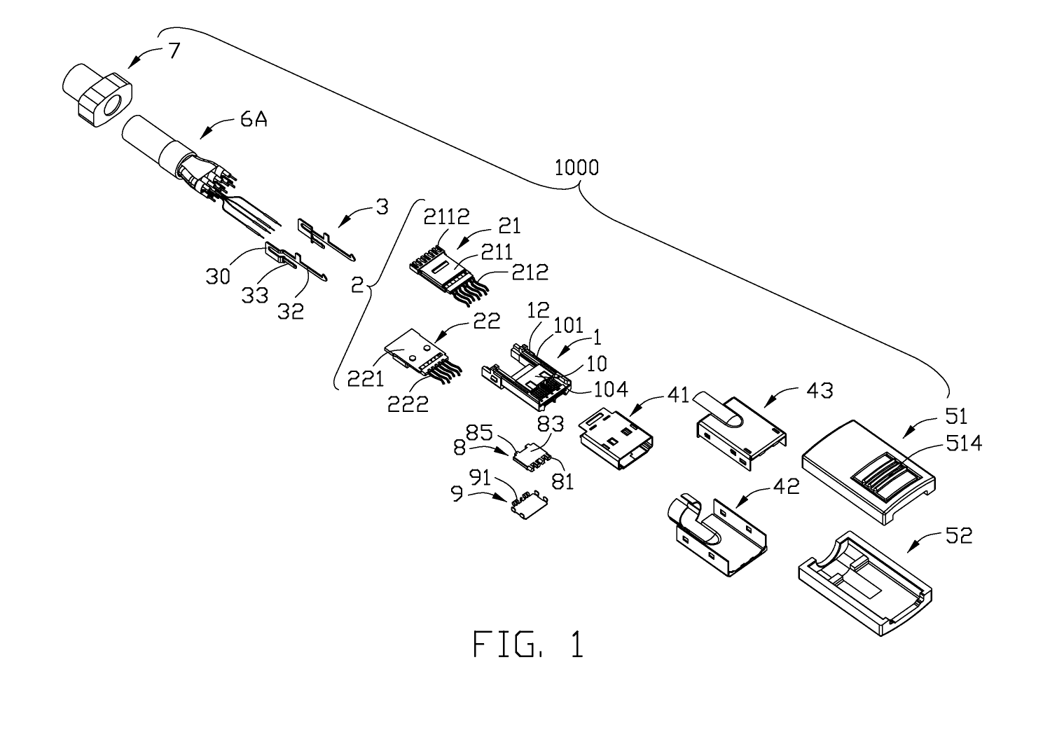

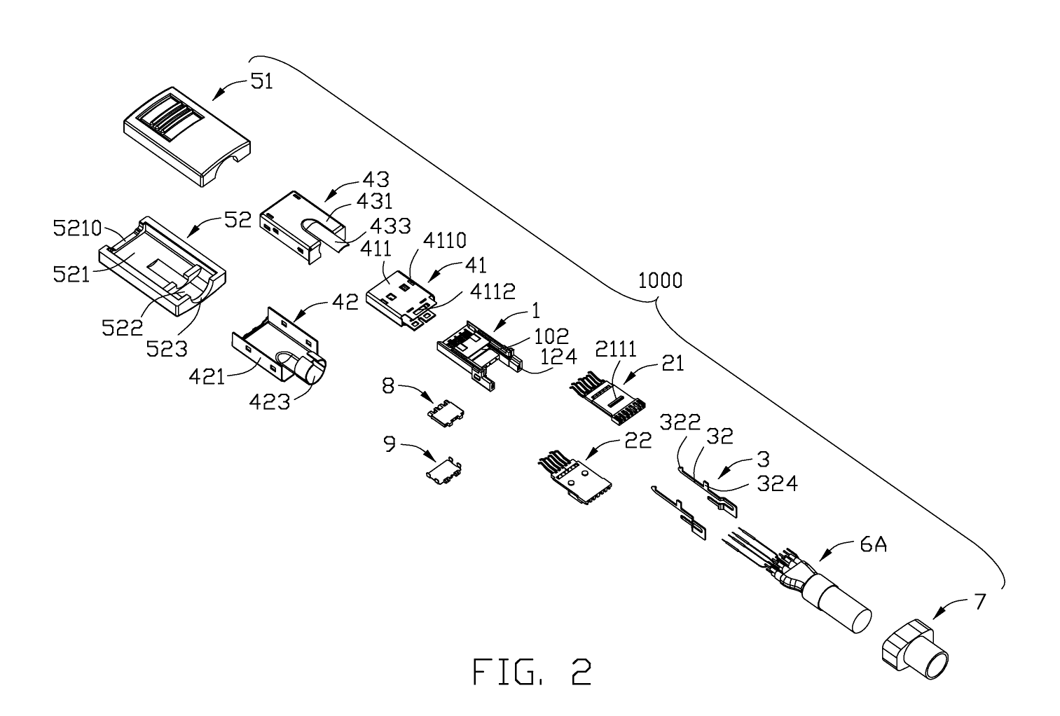

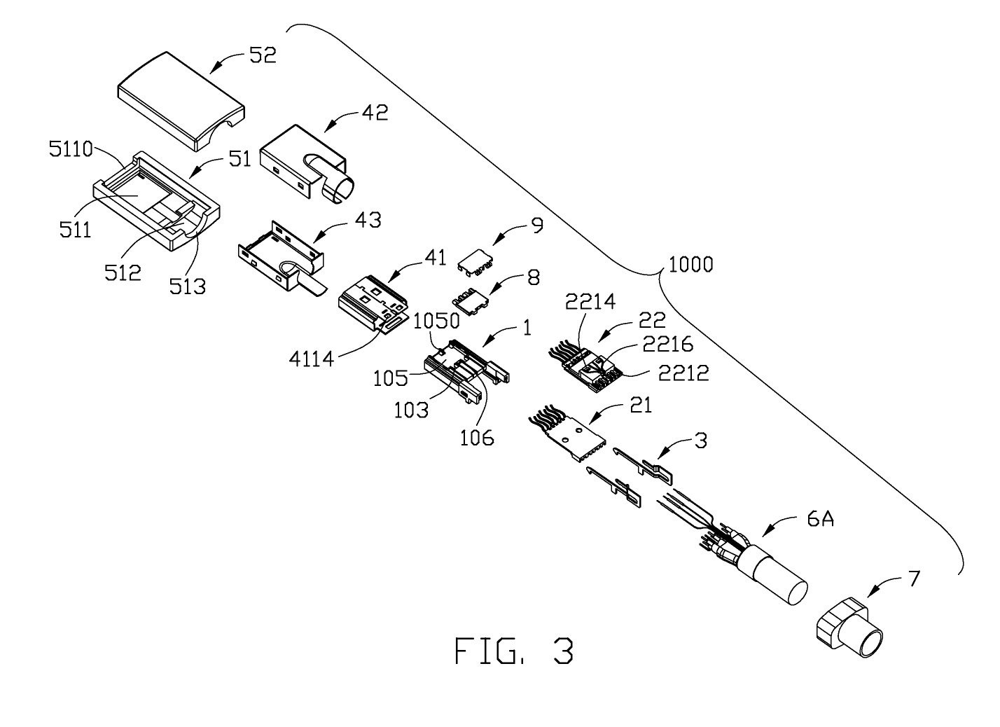

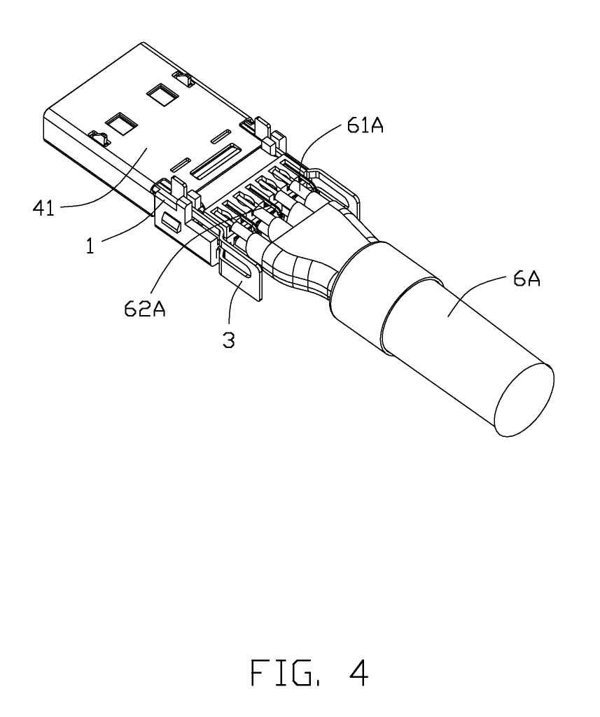

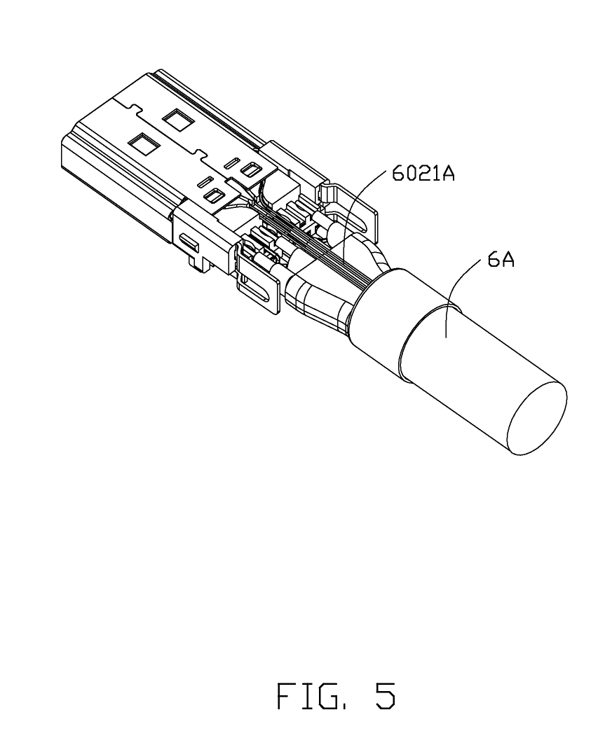

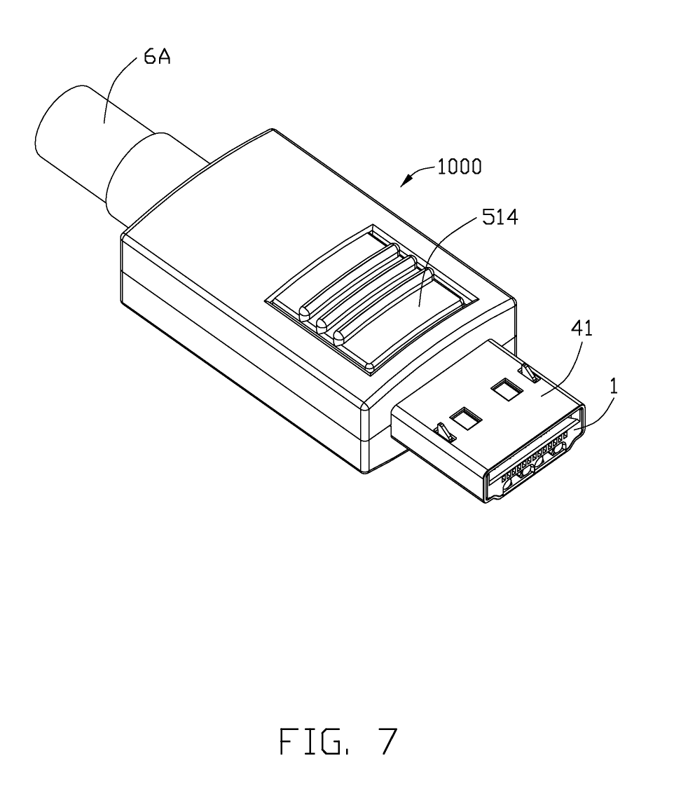

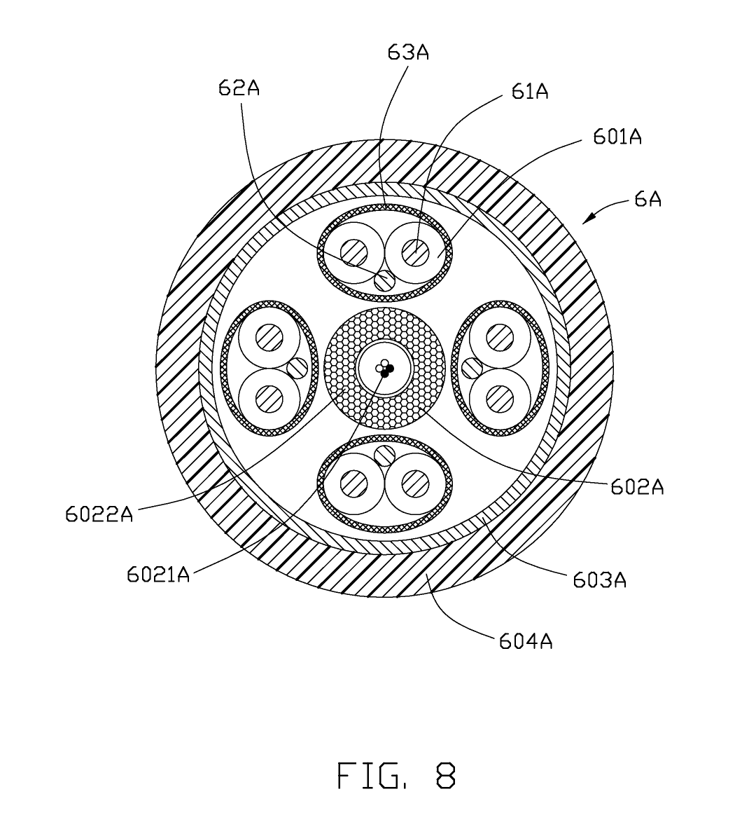

Referring to FIGS. 1-8, a cable assembly 1000 of a first embodiment in accordance with the present invention comprises an insulative housing 1, a terminal module 2, two latching members 3, a metallic shell, an external cover, a hybrid cable 6A, a strain relief 7, an optical module 8 and a cap 9 mounted to the insulative housing 1 to positioning the optical module 8.

The insulative housing 1 includes a main portion 10 and two mounting arms 12 extending rearwardly from lateral sides of the main portion 10. There is a longitudinal slot 101 is defined in a lateral side and a corresponding mounting arm 12. A receiving space 102 is recessed forwardly from a middle segment of a rear edge of the main portion 10. A cavity 104 is recessed downwardly from a front segment of an upper side of the main portion 10 and further communicates with the receiving space 102. A depression 105 is defined in a front section of a lower side of the main portion 10. In addition, there is a stopping portion 1050 disposed in a middle of a front segment of the depression 105. Two positioning slots 103 are located in a back section of the lower side of the main portion 10. The two positioning slots 103 spaced apart from each other along a transversal direction. Four grooves 106 are defined in the back section of the lower side of the main portion 10, and there are two grooves 106 disposed between the two guiding slots 103 and the other two grooves 106 respectively located at outside of the two positioning slots 103.

The terminal module 2 includes a first terminal module 21 and a second terminal module 22. The first terminal module 21 has an insulator 211 and a number of terminals 212 combined together by insert-molding process. The terminals 212 are divided into signal terminals and grounding terminals configured to be longer than the signal terminals. The terminals 212 have contacting portions disposed in front of the insulator 211 and tail portions 2112 located in terminal grooves 2112 in a back section of the insulator 211.

The second terminal module 22 has an insulator 221 and a number of terminals 222 combined together by insert-molding process. The terminals 222 are divided into signal terminals and grounding terminals configured to be longer than the signal terminals. The terminals 222 have contacting portions disposed in front of the insulator 221 and tail portions 2222 located in terminal grooves 2212 in a back section of the insulator 221. There are two protrusions 2214 formed on a central of a bottom side of the insulator 221. In addition, there are four passages 2216 defined in the central of the bottom side of the insulator and disposed around the two protrusions 2214.

The first terminal module 21 and the second terminal module 22 are assembled together along up-to-down direction, with the contacting portions thereof merged into one row, while the tail portions thereof separated into two distinct rows along an up-to-down direction. The first terminal module 21 and the second terminal module 22 are assembled to the insulative housing 1, with front segments of the insulators 211, 221 inserted into the receiving space 102, back segments of the insulators 211, 221 disposed between the two mounting arms 12, the contacting portions extending into the cavity 104.

Each latching member 3 includes a connecting arm 30, a latching arm 32 and a retention arm 33. The latching arm 32 and the retention arm 33 are spaced apart from each other and extend forwardly from the connecting arm 30. The latching arm 32 and the retention arm 33 are located in a first vertical plane. The connecting arm 30 is of U-shaped and locate in second vertical plane which is disposed outside the first vertical plane. A tab 324 is formed on a top side of the latching arm 32. The retention arm 33 is inserted into a positioning hole (not numbered) of the mounting arm 12, and the latching arm 32 is received in the slot 101 of the insulative housing 1. The connecting arm 30 is located behind the mounting arm 12 and adjacent to an outer surface of the mounting arm 12, therefore, more space is formed between the two connecting arms 30.

The metallic shell has a first shell 41, a second shell 42 and a third shell 43. The first shell 41 includes a frame 411 to accommodate the main portion 10 therein. Two through holes 4110 are defined in a front segment of a top side of the frame 411 to allow hooks 322 of the latching arm 32 passing through. There is a positioning hole 4112 defined in a back section of the top side to latch with the protruding portion 2111 of the first terminal module 21. There are two positioning holes 4114 defined in a bottom side of the frame 411 to latch with the protrusions 2214 of the second terminal module 22.

The second shell 42 includes a U-shaped main body 421 and a cable holder 423 integrated with the main body 421 and projecting backwardly. The third shell 43 includes an inverted U-shaped main portion 431 and a tab 433 extending rearward. The second shell 42 and the third shell 43 can be combined together along a vertical direction to accommodate the first and second terminal modules 21, 22.

The external cover includes an upper cover 51 and a bottom cover 52. The upper cover 51 has a first hollow 511 and a second hollow 512 disposed behind the first hollow 511. A rectangular shaped opening 5110 is located in the front portion of the upper cover 51, and the opening 5110 further communicates with the first hollow 511. A semicircular shaped outlet 513 is defined in the rear portion of the upper cover 51 and communicated with the second hollow 512. A deformable button 514 is integrally formed with the upper cover 51 and floatable along up-to-down direction to enter the first hollow 511 so as to actuate the tab 324 of the latching arm 32.

The bottom cover 52 is similar to the upper cover 51, and also has a first hollow 521 and a second hollow 522 disposed behind the first hollow 521. An opening 5210 is located in the front portion of the bottom cover 52, and the opening 5210 further communicates with the first hollow 521. A semicircular shaped outlet 523 is defined in the rear portion of the bottom cover 52 and communicated with the second hollow 522.

The hybrid cable 6A includes four STP (Shielded Twist Pair) wires 601A, a fiber cable 602A, an outer conductive shielding layer 603A enclosing the and the STP wires 601A and the fiber cable 602A, and an outer jacket 604A attached to the outer conductive shielding layer 603A. The hybrid cable 6 has a round cross section, and the four STP wires 601A are symmetrically disposed at two perpendicular diameters of the round cross section, while the fiber cable 602A is located in a center of the round cross section. That is to say, the four STP wires 601A are symmetrically disposed with regarding to the fiber cable 602A. Each STP wire 601A has two twisted wires 61A, a grounding wire 62A disposed adjacent to the two twisted wires 61A and an inner conductive shielding layer 63A enclosing the twisted wires 61A and the grounding wire 62A. The fiber cable 602A has four fiber wires 6021A and a protective layer 6022A shrouding the four fiber wires 6021A. The hybrid cable 6A has a good shielding effect and can endure bending much better.

The optical module 8 includes a number of lenses 81, a seat 83 for supporting the lenses 81 and two guiding members 85 extending backwardly from a back side of the seat 83. The lenses 81 are arranged in a row along a transversal direction and embedded in the seat 83. In addition, the lenses 81 extend beyond front side of the seat 83, with a gap formed front portions of every two adjacent lenses 81. The fiber wires 6021A are respectively coupled to the lenses 81.

The cap 9 is made of metallic sheet and has a planar body 441, two cylindrical shaped first retainers 443 formed at a back side of the planar body 441, and a plurality of second retainers formed at lateral sides of the planar body 441.

The optical module 8 is assembled to the depression 105 of the insulative housing 1, with ends of the two guiding members 85 respectively received in the two positioning slots 103, and the seat 83 of the optical module 8 is also blocked by a stopping portion 1050. The cap 44 is assembled to the insulative housing 1, with the planar body 441 mounted to and shielding the optical module 8, and the first retainers 443 accommodated in the positioning slots 103 and pressing against back edges of the guiding members 85. The second retainers are sandwiched between lateral sides of the seat 83 and inner lateral sides of the depression 105. In addition, the cap 9 is further accommodated in frame 411, sandwiched between the insulative housing 1 and the bottom side 411b of the frame 411. Each fiber wires 6021A pass through a corresponding groove 106 and passage 2216, respectively.

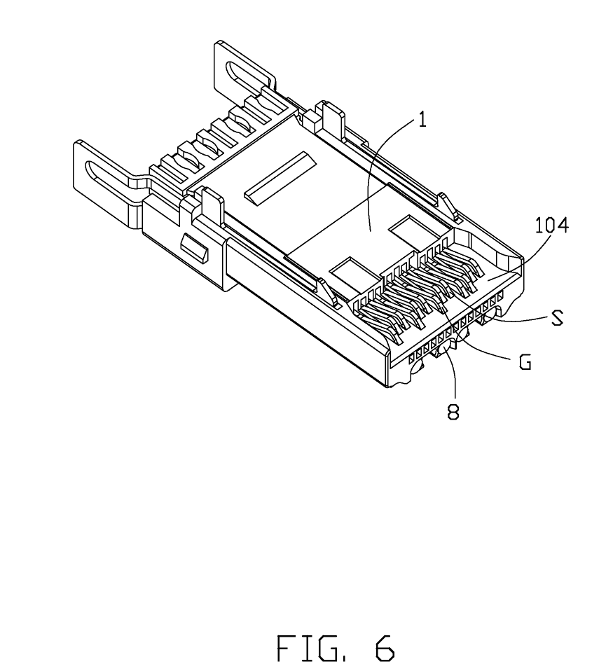

An arrangement of the terminals 212, 222 is in accordance with Digital Interactive Interface for Video & Audio (DiiVA) standard. Referring to FIG. 6 and in conjunction with FIGS. 1-3, within the cavity 104, along a left-to-right direction, the terminals are arranged following G1-S1-S2-G2-S3-S4-G3-S5-S6-G4-G5-S7-S8. G represents grounding terminal, and S represent signal terminal. There are three differential pairs consisted of six signal terminals located between grounding terminals. The differential pairs for high-speed transmitting used for conveying video signals. And a pair of signal terminals disposed in the right side cavity 104 used for audio signals. The differential pairs of the terminals 212, 222 are electrically connected to the STP wires 601A. The differential pairs are soldered to the corresponding twisted wires 61A to transmitting differential signals, and the grounding terminals are soldered to the corresponding grounding wires 62A.

When detach the cable assembly 100 from a complementary connector, just press the deformable button 514 to actuate the tab 324 of the latching arm 32, and the latching arm 32 retreat into the slots 101. When the pressing force is withdrawn, the deformable button 514 restored to its original position and the latching arms 32 also upwardly movement by rebounded force of the resilient tabs 304.

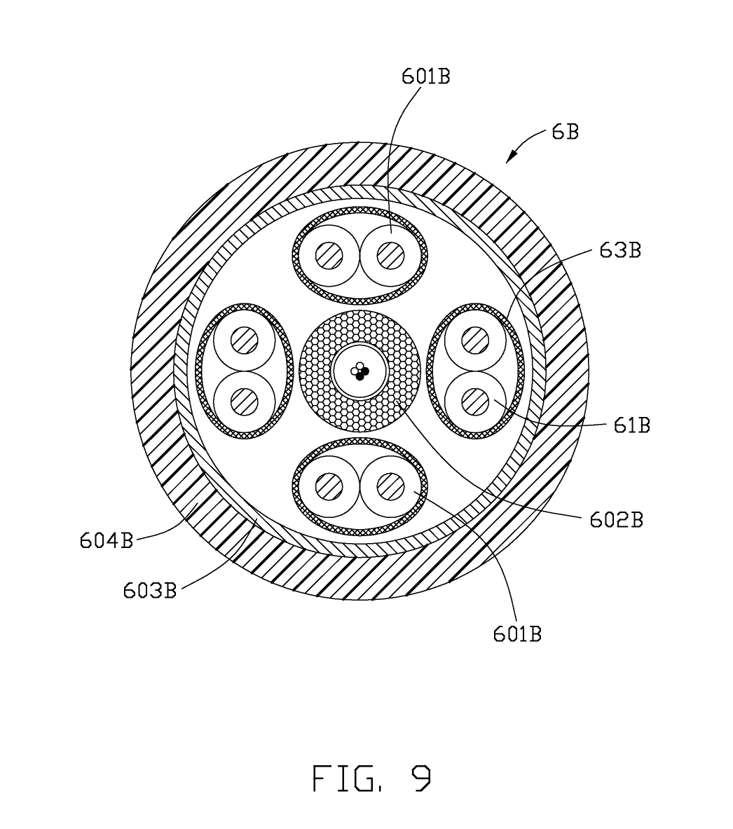

Referring to FIG. 9 and further in conjunction with FIGS. 1-8, a cable assembly of a second embodiment in accordance with the present invention is similar to the first embodiment, excepted that a hybrid cable 6B is different from the hybrid cable 6A, and description of the hybrid cable 6B is given below, and other same elements and their relations of the second embodiment are omitted hereby.

The hybrid cable 6B includes four FTP (Foiled Twist Pair) wires 601B, a fiber cable 602B, an outer conductive shielding layer 603B enclosing the and the FTP wires 601B and the fiber cable 602B, and an outer jacket 604B attached to the outer conductive shielding layer 603B. The hybrid cable 6B has a round cross section, and the four FTP wires 601B are symmetrically disposed at two diameters of the round cross section, while the fiber cable 602B is located in a center of the round cross section. That is to say, the four FTP wires 601B are symmetrically disposed with regarding to the fiber cable 602B. Each FTP wire 601B has two twisted wires 61B, and an inner conductive shielding layer 63B shrouding the two twisted wires 61B. The fiber cable 602B is same as the fiber cable 602A.

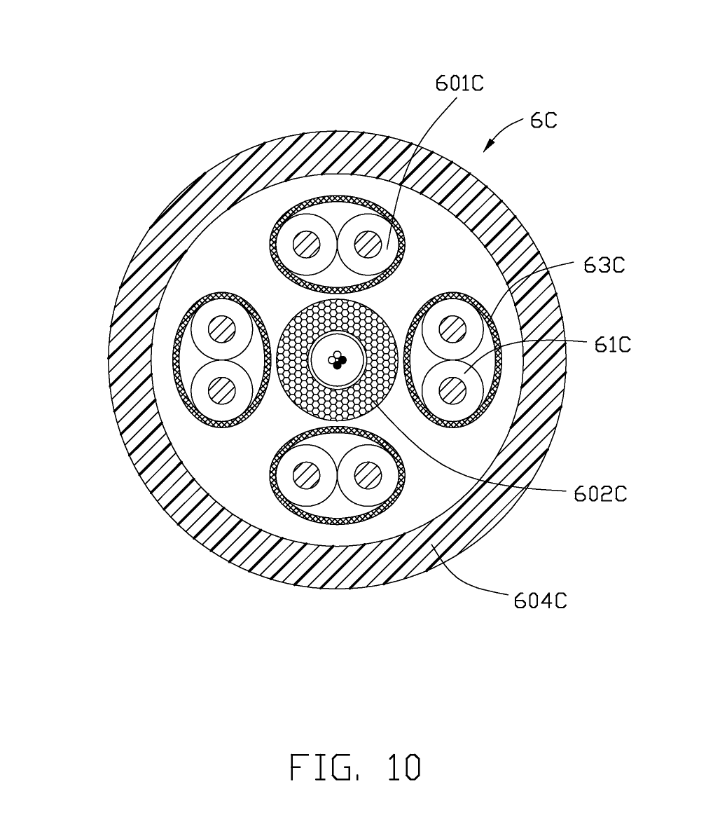

Referring to FIG. 10 and further in conjunction with FIGS. 1-8, a cable assembly of a third embodiment in accordance with the present invention is similar to the first embodiment, excepted that a hybrid cable 6C is different from the hybrid cable 6A, and description of the hybrid cable 6C is given below, and other same elements and their relations of the second embodiment are omitted hereby.

The hybrid cable 6C includes four FTP (Foiled Twist Pair) wires 601C, a fiber cable 602C and an outer jacket 604C enclosing the FTP wires 601C and the fiber cable 602C. The hybrid cable 6C has a round cross section, and the four FTP wires 601C are symmetrically disposed at two diameters of the round cross section, while the fiber cable 602C is located in a center of the round cross section. That is to say, the four FTP wires 601C are symmetrically disposed with regarding to the fiber cable 602C. Each FTP wire 601C has two twisted wires 61C, and an inner conductive shielding layer 63C shrouding the two twisted wires 61C. The fiber cable 602C is same as the fiber cable 602A.

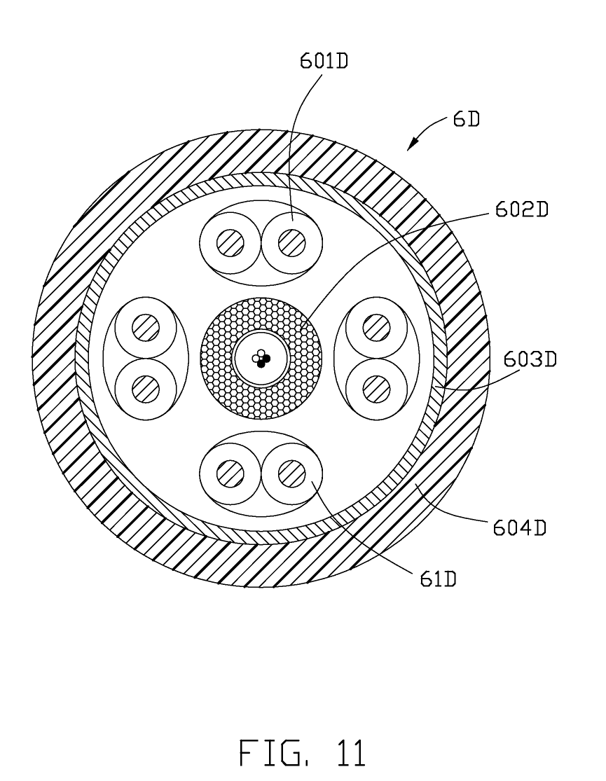

Referring to FIG. 11 and further in conjunction with FIGS. 1-8, a cable assembly of a fourth embodiment in accordance with the present invention is similar to the first embodiment, excepted that a hybrid cable 6D is different from the hybrid cable 6A, and description of the hybrid cable 6D is given below, and other same elements and their relations of the second embodiment are omitted hereby.

The hybrid cable 6D includes four UTP (Unshielded Twist Pair) wires 601D, a fiber cable 602D, an outer conductive shielding layer 603D enclosing the and the UTP wires 601D and the fiber cable 602D, and an outer jacket 604D attached to the outer conductive shielding layer 603D. The hybrid cable 6D has a round cross section, and the four UTP wires 601D are symmetrically disposed at two diameters of the round cross section, while the fiber cable 602D is located in a center of the round cross section. That is to say, the four UTP wires 601D are symmetrically disposed with regarding to the fiber cable 602D. Each UTP wire 601B has two twisted wires 61D. The fiber cable 602D is same as the fiber cable 602A.

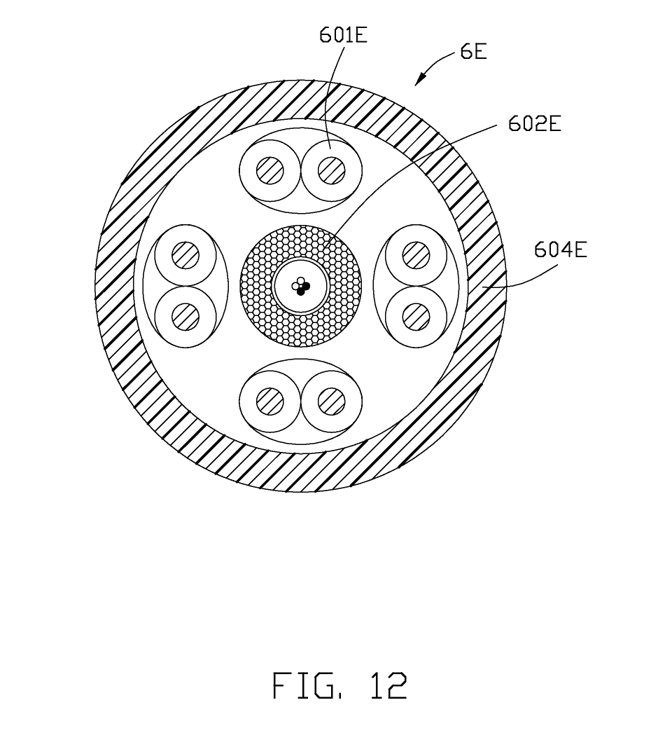

Referring to FIG. 12 and further in conjunction with FIGS. 1-8, a cable assembly of a fifth embodiment in accordance with the present invention is similar to the first embodiment, excepted that a hybrid cable 6E is different from the hybrid cable 6A, and description of the hybrid cable 6E is given below, and other same elements and their relations of the second embodiment are omitted hereby.

The hybrid cable 6E includes four UTP (Unshielded Twist Pair) wires 601E, a fiber cable 602E and an outer jacket 604E enclosing the UTP wires 601E and the fiber cable 602E. The hybrid cable 6E has a round cross section, and the four UTP wires 601E are symmetrically disposed at two diameters of the round cross section, while the fiber cable 602E is located in a center of the round cross section. That is to say, the four UTP wires 601E are symmetrically disposed with regarding to the fiber cable 602E. Each UTP wire 601B has two twisted wires 61D. The fiber cable 602E is same as the fiber cable 602A.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. A cable assembly, comprising:
an insulative housing;
a plurality of terminals received in the insulative housing;
an optical module;
a hybrid cable including at least two STP or FTP wires and a fiber cable, the STP or FTP wires electrically connected with the terminals, the fiber cable optically connected with the optical module; and
the two STP or FTP wires symmetrically arranged with regarding to the optical cable.

2. The cable assembly as recited in claim 1, wherein the hybrid cable has a four STP or FTP wires connected with four pair of terminals, respectively.

3. The cable assembly as recited in claim 1, wherein the hybrid cable has a round cross section, and the four STP or FTP wires are located at two perpendicular diameters of the round cross section.

4. The cable assembly as recited in claim 1, wherein the hybrid cable further has an outer conductive shielding layer enclosing the and the STP or FTP wires and the fiber cable.

5. The cable assembly as recited in claim 4, wherein each STP or UTP wire has two twisted wires and an inner conductive shielding layer enclosing the two twisted wires.

6. The cable assembly as recited in claim 5, wherein there is a grounding wire disposed adjacent to the two twisted wires and enclosed within the inner conductive shielding layer.

7. The cable assembly as recited in claim 4, wherein the hybrid cable further has an outer jacket attached to the outer conductive shielding layer.

8. A cable assembly, comprising:
an insulative housing;
a plurality of terminals received in the insulative housing;
an optical module with a plurality lenses;
a hybrid cable including a plurality of STP or FTP or UTP wires electrically connected to the terminals and a plurality of fiber wires optically connected to the lenses, respectively;
the fiber wires concentrically arranged in a central of the hybrid cable; and
the STP or FTP or UTP wires separated from each other and symmetrically disposed around the fiber wires.

9. The cable assembly as recited in claim 8, wherein the terminals includes a number of differential pairs each are soldered with two twisted wires of the corresponding STP or FTP or UTP wires.

10. The cable assembly as recited in claim 8, wherein the insulative housing includes a main portion defines a receiving space recessed forwardly from a rear edge thereof and a cavity recessed downwardly from a front segment of an upper side of the main portion, and the receiving space communicates with the cavity.

11. The cable assembly as recited in claim 10, wherein there is at least one insulator combined with the terminals to form a terminal module which is assembled to the receiving space, and contacting portions of the terminals are received in the cavity.

12. The cable assembly as recited in claim 11, wherein there is a depression defined in a front section of a lower side of the main portion, and the optical module is accommodated in the depression.

13. The cable assembly as recited in claim 12, wherein there are plurality passages and grooves respectively defined in the insulator and the insulative housing to allow the fiber wires therethrough.

14. The cable assembly as recited in claim 11, further comprising a metallic shell enclosing the terminals and the optical module.

15. The cable assembly as recited in claim 14, wherein there is at least one positioning holes defined in the metallic shell latching with a corresponding protrusion of the terminal module.

16. The cable assembly as recited in claim 14, wherein there is a cap mounted to the insulative housing to position the optical module.

17. The cable assembly as recited in claim 16, wherein the cap is sandwiched between the metallic shell and the insulative housing.

18. A cable connector assembly comprising:
an insulative housing including an optical port and an electrical port;
a plurality of electrical terminals disposed in the electrical port;
a plurality of optical lenses disposed in the optical port;
a hybrid cable including a plurality of electrical wires electrically connected to the corresponding terminals, respectively, and a plurality of optical fibers coupling to the corresponding lenses, respectively, under condition that the optical fibers are concentrically located at a center region of the cable and the electrical wires divided into different groups and essentially symmetrically surround said optical fibers.

19. The cable connector assembly as claimed in claim 18, wherein a protective layer intimately surrounds the optical fibers.

20. The cable connector assembly as claimed in claim 19, wherein a metallic shielding layer surrounds each corresponding group of the electrical wires.
